(19) United States
(12) Patent Application Publication
(10) Pub. No.: US 2019/0121945 A1
(43) Pub. Date: Apr. 25, 2019

(54) Electronic Medical Record Visual Recording and Display System

(71) Applicants: Johny Vattathara, Ballwin, MT (US); Laiju Paul, Ballwin, MT (US)

(72) Inventors: Johny Vattathara, Ballwin, MT (US); Laiju Paul, Ballwin, MT (US)

(21) Appl. No.: 15/790,044

(22) Filed: Oct. 22, 2017

(51) Int. Cl. G06F 19/00; G06F 3/0484

(52) U.S. Cl. CPC G06F 19/3406; G06F 3/04845; G06F 3/04842; G06F 19/322

(57) ABSTRACT

The invention is a system and method for recording and displaying electronic medical records. This EMR system enables doctors to represent medical issues of a patient as interactive hotspots on a human body image so that they present a comprehensive visual overview of a patient's condition. The diagnostic hotspots can be moved to different areas of the body. The particular area of the body that a hotspot is located at can determine a list of suggested ICD codes to indicate the medical condition associated with the hotspot. The diagnostic hotspots can also be color coded or animated to indicate the seriousness or priority of a medical issue.

### BACKGROUND

When a patient visits a doctor or other medical professional, the doctor typically records notes regarding the patient's condition. These notes are then reviewed before and during subsequent visits. These notes are also added to during subsequent visits and form a patient's medical record. Currently, there are many software applications available for doctors to record and review notes in an electronic format. Notes stored electronically are referred to as electronic medical records (EMR).

With standard EMR applications, doctors dictate patient notes in free form text format. This is not the most efficient way to record or review notes, as there are different formats for storing and ordering notes (e.g. chronological vs. grouped by condition). It would be beneficial to have a software application capable of recording and reviewing notes by associating the notes with various areas on an image of a human body. There are various benefits to the method of recording and reviewing notes by associating the notes with various areas on an image of a human body, such as the ability to quickly understand active issues of the patient just by looking at the profile image and identify areas of the body requiring attention, increased quality of treatment due to better understanding of patients' issues, time saved with shorter encounters, etc. This also helps minimize the impact of patients' lack of language skills and other memory related illnesses.

Additional improvement can be made to such an EMR application, such as indicating severity level by color, indicating disposition by animations, and the ease of updating prognosis with changed ICD codes along with moving hotspots graphically on a human body image.

### SUMMARY

This invention relates to a system and method for entering and storing electronic medical records (EMR). The main feature of this EMR system is its interactive pictorial representation and mapping of patient medical information on a human body image. Doctors are able to visually look at the patient's medical information with respect to the various parts of the body and quickly drill down into specific details. This EMR system enables doctors to represent medical issues of a patient as interactive hotspots on a human body image so that they present a comprehensive visual overview of a patient's condition.

This system also can map these diagnostic hotspots, representing medical issues to appropriate ICD codes. These hotspots can be moved anywhere on a patient's image allowing the physician to narrow down a set of medical ICD codes associated to that section of the body. The diagnostic hotspots can also be color coded or animated to indicate the seriousness or priority of a medical issue. This feature would greatly reduce the time spent by a physician or caregiver on understanding a patient and allow for more quality time to interact with the patient.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is a flow chart illustrating the process of adding a hotspot in an example embodiment of the system.

FIG. 2 is a flow chart illustrating the process of moving a hotspot in an example embodiment of the system.

FIG. 3 is a flow chart illustrating the process of coloring a hotspot in an example embodiment of the system.

FIG. 4 is a flow chart illustrating the process of animating a hotspot in an example embodiment of the system.

FIG. 5 is a flow chart illustrating the process of listing suggested ICD codes in an example embodiment of the system.

### DETAILED DESCRIPTION

In the preferred embodiment, an anatomical image of a human body is used in a software application to reference the areas of the human body relevant to a doctor-patient interaction. ICD codes can be associated with specific areas of the human body image. This approach gives the doctor better visual cues to understand where to focus the interaction.

In the preferred embodiment, the system may be comprised of a single computing device, such as a desktop personal computer, notebook, tablet or mobile telephone; or a number of devices connected via a network, including a client-server configuration. The computing device(s) may include a processor, memory, and a user interface in any form.

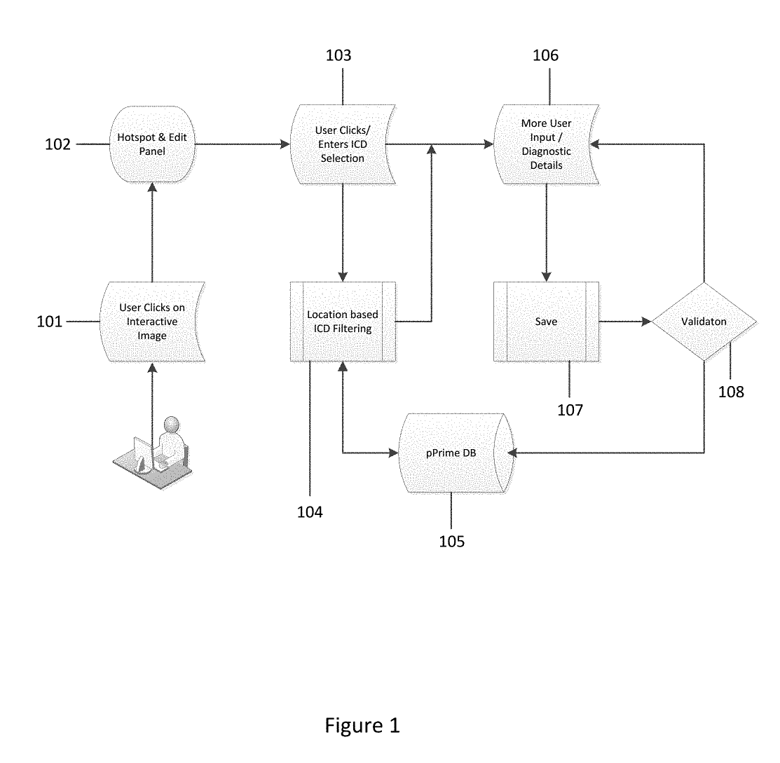

The particular embodiment illustrated in FIG. 1 describes the process of adding a “hotspot” to an anatomical image of a human body. A hotspot is a graphical indication of medical information associated with a particular location on a human body. The process of adding a hotspot begins with user interaction 101, where a user indicates the location of a new hotspot. This can be achieved by manipulating and clicking a mouse input device connected to a desktop or laptop computer, or by activating a touch screen that is part of a mobile phone, tablet computer, laptop computer, or other device capable of receiving tactile input from a human finger or stylus.

After user interaction 101 indicates the location of a new hotspot, hotspot and edit panel 102 is displayed on a display device. Hotspot and edit panel 102 displays information about the hotspot, such as the associated body area and ICD code selection. ICD codes, or International Classification of Diseases, are alphanumeric codes used by doctors and other medical professionals to describe medical diagnoses.

Hotspot and edit panel 102 allows editing of hotspot information, such as selection of an ICD code. ICD selection 103 allows a user to select an ICD code by indicating the desired code from a list of prospective codes. The desired code can be indicated by a mouse input device or touch input as described previously.

ICD filter 104 reduces the list of prospective ICD codes by querying database 105 and receiving a list of ICD codes that are potentially associated with the body location of the hotspot.

Additional user interaction 106 allows a user to input additional information to be associated with the hotspot. A user may enter diagnostic details or other notes by typing on a keyboard or touch screen input. A user may also indicate that the hotspot is to be saved, which will initiate save process 107.

Save process 107 will initiate validation process 108. Validation process 108 will verify that the information associated with the hotspot is valid, then write the information to database 105.

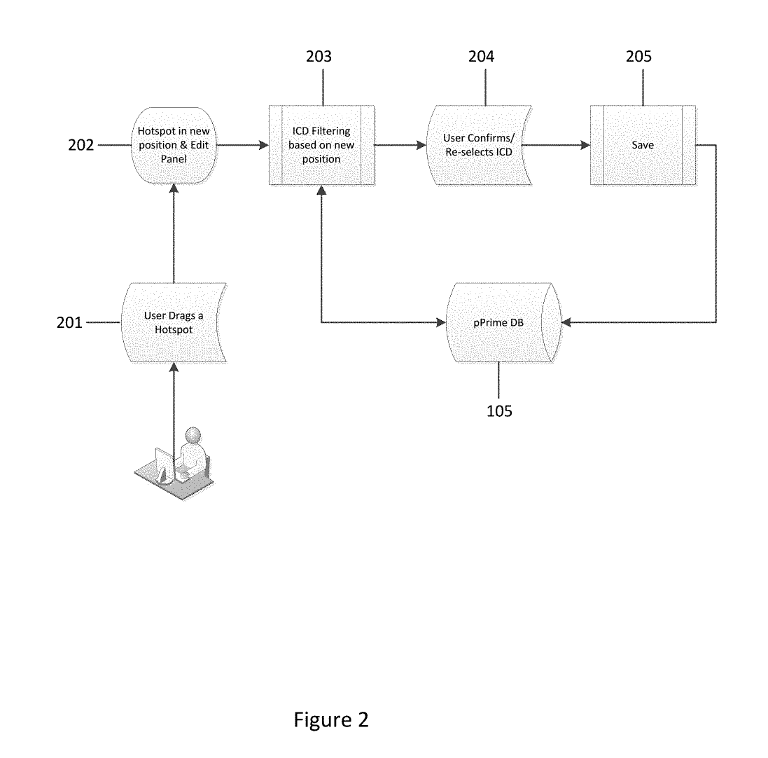

The particular embodiment illustrated in FIG. 2 describes the process of moving a hotspot to a different location on an anatomical image of a human body. The process of moving a hotspot begins with user interaction 201, where a user indicates the new location of a hotspot. This can be achieved by manipulating a mouse input device or a touch screen to drag an existing hotspot to a new location.

After user interaction 201 indicates the new location of a hotspot, hotspot and edit panel 202 is displayed on the display device. Hotspot and edit panel 202 displays information about the hotspot, such as the associated body area and ICD code selection. Hotspot and edit panel 202 also initiates ICD filter 203.

ICD filter 203 reduces the list of prospective ICD codes by querying database 105 and receiving a list of ICD codes that are potentially associated with the new body location of the hotspot.

After the list of prospective ICD codes is filtered by ICD filter 203, ICD selection 204 allows the user to select an ICD code by indicating the desired code from the list of prospective codes. The desired code can be indicated by a mouse input device or touch input as described previously.

After a user has selected an ICD code, the display device prompts the user if he or she would like to save. If the user indicates that he or she would like to save, then save process 205 is initiated.

Save process 205 writes the hotspot and associated information to database 105.

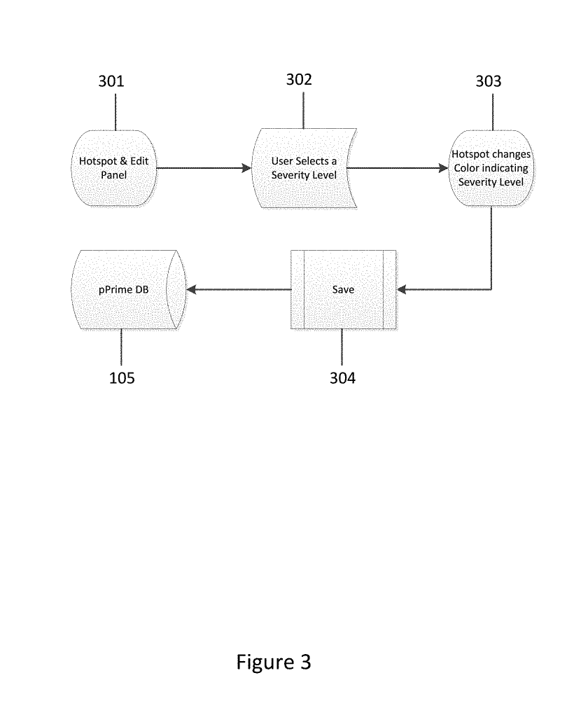

The particular embodiment illustrated in FIG. 3 describes the process of coloring a hotspot to indicate a particular severity level for that hotspot. The process of coloring a hotspot begins with hotspot and edit panel 301. From here, several interactions are available at user interaction 302.

At user interaction 302, a user can indicate a severity level, such as low, medium, or high, by manipulating a mouse input device or a touch screen to indicate the desired severity level. Once the user has indicated a desired severity level, hotspot color change 303 is initiated.

At hotspot color change 303, the graphical representation of the hotspot has its color updated to indicate the desired severity level. The user is then prompted by the display device to save. If the user indicates that he or she would like to save, then save process 304 is initiated.

Save process 304 writes the hotspot severity level information to database 105.

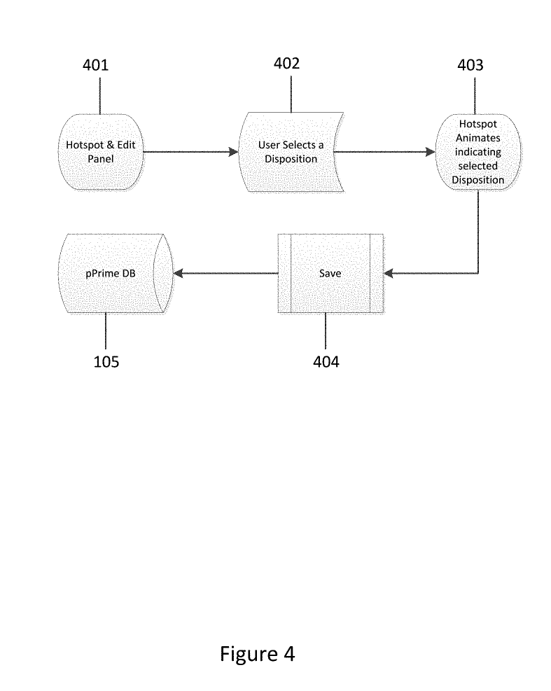

The particular embodiment illustrated in FIG. 4 describes the process of animating a hotspot to indicate a particular disposition for that hotspot. The process of animating a hotspot begins with hotspot and edit panel 401. From here, several interactions are available at user interaction 402.

At user interaction 402, a user can indicate a disposition, such as diagnosed or needs attention, by manipulating a mouse input device or a touch screen to indicate the desired disposition. Once the user has indicated a desired disposition, hotspot animation 403 is initiated.

At animation 403, the graphical representation of the hotspot is animated to indicate the desired disposition, such as by blinking. The user is then prompted by the display device to save. If the user indicates that he or she would like to save, then save process 404 is initiated.

Save process 404 writes the hotspot disposition information to database 105.

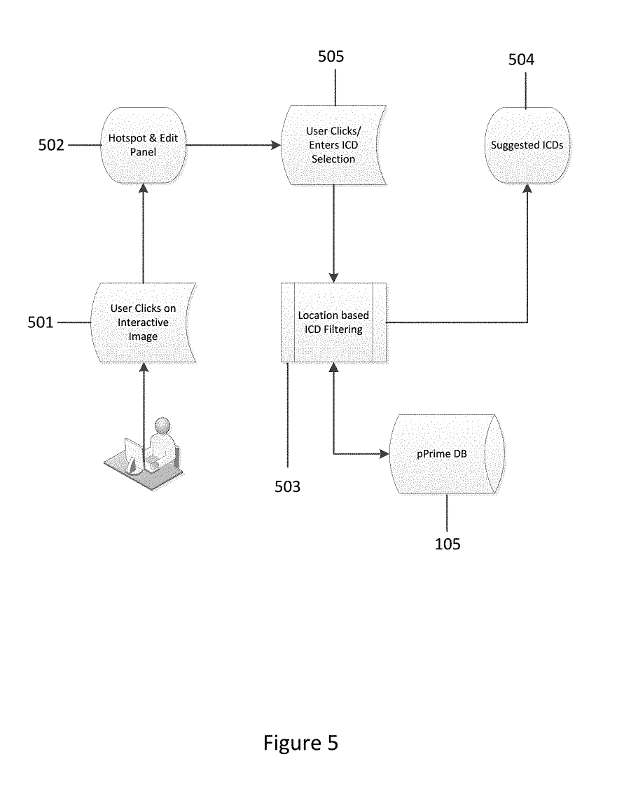

The particular embodiment illustrated in FIG. 5 describes the process of listing suggested ICD codes. The process of listing suggested ICD codes begins with user interaction 501.

At user interaction 501, a user indicates the location of a hotspot, which can be a new hotspot or an existing hotspot. This can be achieved by manipulating a mouse input device or a touch screen to select a location.

After user interaction 501 indicates the location of a hotspot, hotspot and edit panel 502 is displayed on the display device. Hotspot and edit panel 502 displays information about the hotspot, such as the associated body area and ICD code selection. Hotspot and edit panel 502 also initiates user interaction 505 once a user clicks or enters an ICD selection.

User interaction 505 initiates ICD filter 503. ICD filter 503 reduces the list of prospective ICD codes by querying database 105 and receiving a list of ICD codes that are potentially associated with the body location of the hotspot.

After the list of prospective ICD codes is filtered by ICD filter 503, suggested ICD list 504 is displayed on the display device.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

What is claimed is:

1. An electronic medical records system comprising:
a processor;
a computer readable storage media that comprises instructions stored in the computer readable storage media that are executable with the processor, the instructions comprising:
instructions to display an anatomical human image;
instructions to display a hotspot, highlighting the selected area, in response to an area selection command indicative of a user selecting an area of the anatomical human image;
instructions to display a list of ICD codes in response to an area selection command indicative of a user selecting an area of the anatomical human image;
instructions to receive user entry of patient specific data in response to an ICD code selection command.

2. The electronic medical records system of claim 1, further comprising:
instructions to display a color-coded hotspot on an anatomical human image.

3. The electronic medical records system of claim 1, further comprising:
instructions to display an animated hotspot on an anatomical human image.

4. The electronic medical records system of claim 1, further comprising:
instructions to display a hotspot in another location in response to an area selection command indicative of a user selecting an area of the anatomical human image after a hotspot selection command indicative of a user selecting an existing hotspot.

5. A method of creating electronic medical records comprising:
displaying with a display device an anatomical human image;
in response to receipt from a selection device of an area selection command:
retrieving from a database and displaying with the display device a list of ICD codes;
in response to receipt from the selection device of an ICD code selection command:
displaying with the display device a patient data entry form;
in response to receipt from the selection device of patient specific data:
displaying with the display device an anatomical human image with the area associated with the patient specific data a different color than the rest of the image.
